(19) United States
(12) Patent Application Publication
(10) Pub. No.: US 2008/0072079 A1
(43) Pub. Date: Mar. 20, 2008

(54) System and Method for Implementing Predictive Capacity on Demand for Systems With Active Power Management

(76) Inventors: Andreas Bieswanger, Ehningen (DE); Andrew Geissler, Austin, TX (US); Hye-Young McCreary, Liberty Hill, TX (US); Naresh Nayar, Rochester, MN (US); Freeman L. Rawson, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/532,333

(22) Filed: Sep. 15, 2006

(51) Int. Cl. G06F 1/00

(52) U.S. Cl. 713/300

(57) ABSTRACT

A method, apparatus, and computer-usable medium for predicting capacity on a data processing system. According to a preferred embodiment of the present invention, a capacity manager estimates an incremental power value utilize for activating and maintaining an additional processor in the data processing system. The capacity manager calculates a power headroom value. In response to calculating the power headroom value, the capacity manager determines whether an adjustment power headroom value is required. The capacity manager calculates a projected capacity value added by the additional processor to the data processing system.

### BACKGROUND OF THE INVENTION

1. Technical Field

The present invention relates in general to the field of data processing systems. More specifically, the present invention relates to the field of power management of data processing systems. Still more particularly, the present invention relates to a system and method for implementing predictive capacity on demand for data processing systems with active power management.

2. Description of the Related Art

Some modern computer system include an option of “upgrade-on-demand”, which enables a user to purchase a computer system with m number of processors, but only license the use of k processors. Typically k is strictly less than m. Prior to the introduction of power management schemes in computer systems, the effect of an upgrade action, where the user licenses the use of more processors, was very predictable. In a power-managed environment, an upgrade may change the power settings of the processors, including processor frequency and throttling, which may result in a system with fewer available total processor cycles than prior to the upgrade.

Therefore, there is a need for a system and method for addressing the aforementioned limitations of the prior art.

### SUMMARY OF THE INVENTION

The present invention includes a method, apparatus, and computer-usable medium for predicting capacity on a data processing system. According to a preferred embodiment of the present invention, a capacity manager estimates an incremental power value utilize for activating and maintaining an additional processor in the data processing system. The capacity manager calculates a power headroom value. In response to calculating the power headroom value, the capacity manager determines whether an adjustment power headroom value is required. The capacity manager calculates a projected capacity value added by the additional processor to the data processing system.

The above, as well as additional purposes, features, and advantages of the present invention will become apparent in the following detailed written description.

### BRIEF DESCRIPTION OF THE FIGURES

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, wherein:

FIG. 1 is a block diagram illustrating an exemplary data processing system in which a preferred embodiment of the present invention may be implemented;

FIG. 2 is a block diagram depicting exemplary contents of the system memory as illustrated to FIG. 1; and

FIG. 3 is a high-level logical flowchart diagram illustrating an exemplary method for implementing predictive capacity on demand for systems with active power management according to a preferred embodiment of the present invention.

### DETAILED DESCRIPTION OF A PREFERRED EMBODIMENT

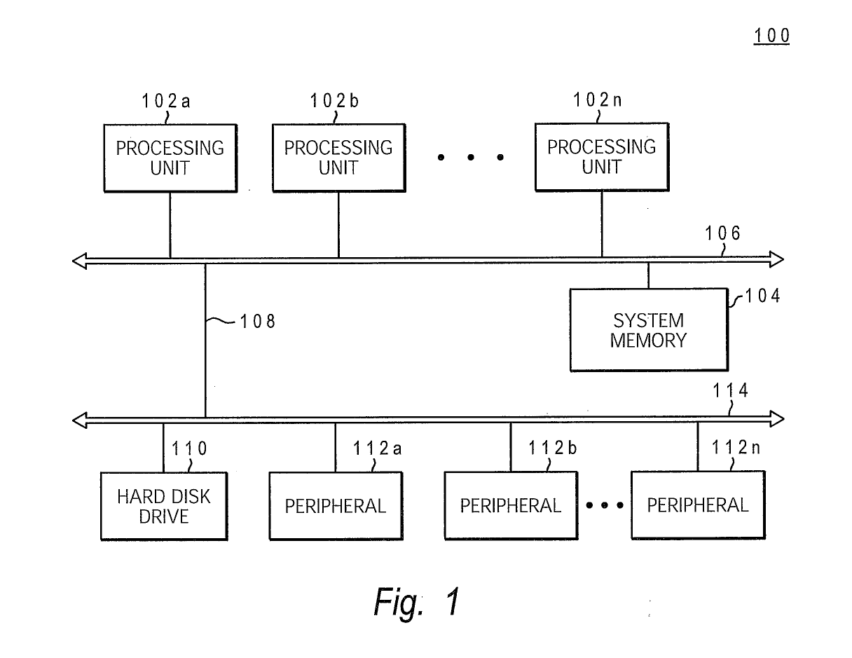

Referring to the figures, and more particularly, referring now to FIG. 1, there is illustrated a block diagram of an exemplary data processing system in which a preferred embodiment of the present invention may be implemented. As depicted, exemplary data processing system 100 includes processor(s) 102a-n, which are coupled to system memory 104 via system bus 106. Preferably, system memory 104 may be implemented as a collection of dynamic random access memory (DRAM) modules. Mezzanine bus 108 acts as an intermediary between system bus 106 and peripheral bus 114. Those with skill in this art will appreciate that peripheral bus 114 may be implemented as a peripheral component interconnect (PCI), accelerated graphics port (AGP), or any other peripheral bus. Coupled to peripheral bus 114 is hard disk drive 110, which is utilized by data processing system 100 as a mass storage device. Also coupled to peripheral bus 114 is a collection of peripherals 112a-n.

Those skilled in the art will appreciate that data processing system 100 can include many additional components not specifically illustrated in FIG. 1. Because such additional components are not necessary for an understanding of the present invention, they are not illustrated in FIG. 1 or discussed further herein. It should also be understood, however, that the enhancements to data processing system 100 for implementing predictive capacity on demand for systems with active power management provided by the present invention are applicable to data processing systems of any system architecture and are in no way limited to the generalized multi-processor architecture or symmetric multi-processing (SMP) architecture illustrated in FIG. 1.

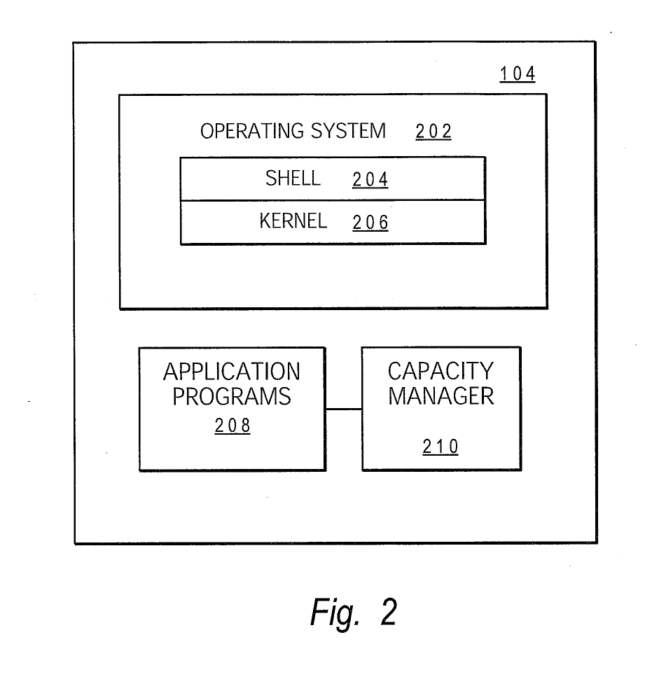

FIG. 2 is a block diagram illustrating exemplary contents of system memory 104 of data processing system 100, according to a preferred embodiment of the present invention. As illustrated, system memory 104 includes operating system 202, which further includes shell 204 for providing transparent user access to resources of data processing system 100. Generally, shell 204 is a program that provides an interpreter and an interface between the user and the operating system. More specifically, shell 204 executes commands that are entered into a command line user interface or a file. Thus, shell 204 (as it is called in UNDI®), also called a command processor in Windows®, is generally the highest level of the operating system software hierarchy and servers as a command interpreter. The shell provides a system prompt, interprets commands entered by keyboard, mouse, or other user input media, and sends the interpreted command(s) to the appropriate lower levels of the operating system (e.g., kernel 206) for processing. Note that while shell 204 is a text-based, line-oriented user interface, the present invention will support other user interface modes, such as graphical, voice, gestural, etc. equally well.

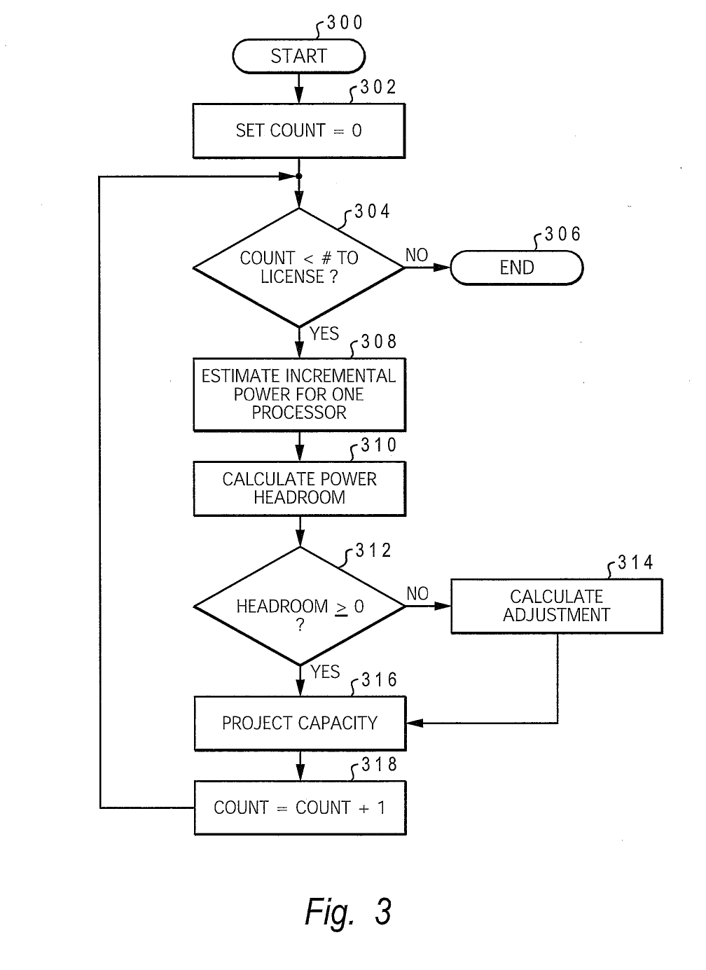

As illustrated, operating system 202 also includes kernel 206, which includes lower levels of functionality for operating system 202, including providing essential services required by other parts of operating system 202 and application programs 208, including memory management, process and task management, disk management, and mouse and keyboard management. Application programs 208 can include a browser, utilized for access to the Internet, word processors, spreadsheets, and other application programs. Also included in system memory 104 is capacity manager 210, which performs calculations to implement predictive capacity on demand for systems with active power management, discussed herein in more detail in conjunction with FIG. 3.

Several terms will be defined and assumptions will be made to facilitate discussion of a preferred embodiment of the present invention.

The present invention predicts the effect of licensing one or more additional processing units 102a-n on the number of available processor cycles in the system, wherein the number of available cycles is the sum of the effective frequencies of each of the licensed processing units 102a-n in data processing system 100, which is defined as the “capacity” of data processing system 100.

Capacity=ΣEffectiveFrequency(p), wherein p represents an individual processor, one of units 102a-n in data processing system 100. The sum runs over all of the licensed processing units in the system.

As utilized herein, “Capacity(n)” represents the capacity of data processing system 100 under the current conditions and power management policy when n processing units are licensed. Also, as utilized herein, the effective frequency of a processing unit is defined as:

EffectiveFrequency=ActualFrequency*(1-Throttling), wherein “Throttling” is the fraction of cycles rendered unusable by one of the processing unit throttling mechanisms. A preferred embodiment of the present invention makes the assumption that there is a single, global, actual frequency utilized by all of processing units 102a-n. This is actually not a necessary feature: it simply represents a restriction imposed by other factors on pending IBM implementations of the technology. The throttling feature found in modern processing units has the effect of making one or more cycles in a particular set of cycles unusable, which stalls the processing unit for a period of time. The result of this throttling feature is similar to reducing the frequency at which a processing unit operates although the power benefits are less and throttling is a per-processor setting rather than a global setting of the system.

According to a preferred embodiment of the present invention, assume that the source of the additional power consumed on a capacity upgrade is the additional processing units licensed and active, as measured by capacity manager 210, and that the power consumed by the remainder of data processing system 100 remains constant. While the use of additional processing units 102a-n may lead to additional memory and I/O usage, the differences should be relatively insignificant, especially if the memory and I/O devices are also power managed. Thus, the total power, as measured by capacity manager 210 at any time, is expressed as:

MeasuredPower=MeasuredProcessorPower+BasePower

Also, according to a preferred embodiment of the present invention, assume that the power consumed by the unlicensed processing units is relatively small and can be included in “BasePower”. For simplicity, the reduction in the base power due to a processing unit licensing operating is ignored. The limitation on the power consumed is on the consumption of the entire data processing system 100 and is expressed as:

PowerLimit=minimum(DesignPowerLimit, PowerCap)

Powerlimit includes the base power due to the components other than the processing units, which is taken to be a fixed value. So, to simplify the notation below, the following calculation defines the power limit on the processing unit pool:

ProcessorPowerLimit=PowerLimit−BasePower.

The prediction calculated by capacity manager 210 is performed by taking advantage of the power measurement capabilities of data processing system 100. Data processing system 100 has information that indicates the current power limit and thus, the processing unit power limit, due to either the designed-in limits of the implementation or a power cap imposed by the user. Data processing system 100 also provides measurement data that indicates how much of the available power is actually being utilized. By subtracting the fixed, base power, capacity manager 210 can approximate the amount of power sent to currently-licensed processing units, as defined by:

MeasuredProcessorPower=MeasuredPower−Base Power.

The difference between ProcessorPowerLimit and MeasuredProcessorPower is the power headroom (PHR), which is defined by:

PHR=ProcessorPowerLimit−MeasuredProcessorPower.

The PHR measures how much additional power load from newly-licensed processing units data processing system 100 can tolerate before invoking the power management system. For a data processing system 100 in steady state with no pending licensing actions, PHR is always greater than or equal to 0.

A main idea behind the prediction scheme addressed in a preferred embodiment of the present invention is to approximate the additional load due to licensing one additional processor, add that load to the measure processor power and compute an updated value for PHR. The new value of PHR may be positive, zero or negative. If it is greater than or equal to zero, then capacity manager 210 does not need to change the power settings. If the value of PHR is negative, capacity manager 210 has to initiate action that affects the amount of new capacity added by licensing new processing units.

According to a preferred embodiment of the present invention, capacity manager 210 predicts the additional power burden imposed by a newly-licensed processing unit. The incremental power use due to licensing a new processor is the currently measured processor power divided by the number of currently licensed processing units. The currently measured processor power is not a single, instantaneous measurement. Instead, to avoid instabilities, the currently measured processor power value is an average of the measured power minus the base power over an interval. According to another preferred embodiment of the present invention, a more conservative method of determining the currently-measured processor power value utilizes the maximum power observed rather than taking the average. The length of the interval is implementation-dependent, but is on the order of several minutes to several hours. The incremental power is always approximated utilizing the current effective frequency with the assumption that it can be approximated by the average of the effective frequencies of the currently licensed processing units. The average of the effective frequencies is taken utilizing a capacity value that is the average of the capacities over the same intervals as the power data.

AverageEffectiveFrequency=(Capacity/Number of Licensed Processing units)

The processing unit power is expressed as:

ProcessorPower(AverageEffectiveFrequency)=(MeasuredProcessorPower/NumberofLicensedProcessingUnits)

Capacity manager 210 predicts a new value of PHR based on:

Projected PHR=PHR−ProcessorPower(AverageEffectiveFrequency).

To simplify the notation herein, ProcessorPower(AverageEffectiveFrequency) is expressed as “PPROC”. If the value of the projected PHR is non-negative, then the prediction is that the additional processing unit will not affect the power management settings of data processing system 100 and the incremental number of processing unit cycles is equal to AverageEffectiveFrequency, which results in the following calculation:

NewCapacity=Capacity+AverageEffectiveFrequency

If the value of the projected PHR is negative, adding the processing unit affects the current power settings. Capacity manager 210 assumes that the power management mechanism spreads the effect across the previously-licensed processing units to accommodate the additional processing unit with a resulting new value of ProjectedPHR=0. The new capacity is the product of a scaling factor and the sum of the current capacity plus the AverageEffectiveFrequency. The amount of additional scaling is proportional to the cube root of the ratio of the absolute value of the current projected PHR.

According to a preferred embodiment of the present invention, the goal is to determine how much to scale the frequency of processing units 102a-n based on the required reduction in the processing unit power to get back to a headroom of zero, or to find the value required to make PHR=PPROC.

ProjectedPHR=ProcessorPowerLimit−(MeasuredProcessorPower+PPOC)

Projected PHR=ProcessorPowerLimit−(MeasuredProcessorPower+(MeasuredProcessorPower/NumberOfLicensedProcessors))

ProjectedPHR=ProcessorPowerLimit−(1+(1/NumberofLicensedProcessors))*MeasuredProcessorPower.

If ProjectedPHR is negative, the change needed is the absolute value of ProjectedPHR.

|ProjectedPHR|=(1+(1/NumberofLicensedProcessors))*MeasuredProcessorPower−ProcessorPowerLimit

To determine the effect on the average effective frequency, the change has to be spread across all of the licensed processing units, including the newly-licensed processing unit. Thus, the power change required for each processing unit is expressed by:

ChangeInPowerPerProcessor=(|ProjectedPHR])/(NumberofLicensedProcessors+1).

At this point, it is very important to note that the change in frequency is determined by the amount of change in the processing unit power per processing unit required. The amount of adjustment in the frequency is proportional to the cube root of the amount of power adjustment for each processing unit since power is approximately proportional to the cube of the frequency. Thus, the projected new capacity after increasing the number of licensed processing units by one in the case in which the headroom is insufficient is expressed as:

NewCapacity=((EffectiveFrequency−b*(ChangeInPowerPerProcessor)̂(⅓))*NumberofficensedProcessors+1)), where b is a constant of proportionality.

The use of the cube root is based on the fact that processing unit power is approximately cubic in the frequency assuming suitable voltage adjustments and that power management is performed primarily by dynamic voltage and frequency scaling. For computer systems that support only processor throttling, the constant of proportionality may expressed as proportional to the change in processor power rather than its cubic root since if only throttling is used with no voltage adjustment, power is approximately linear in frequency. In cases where the current capacity is much greater than EffectiveFrequency, the new capacity may be less than the current capacity. If the upgrade is for more than a single processing unit, then the prediction is repeated as many times as is necessary to predict the result of licensing the requested number of additional processing units.

FIG. 3 is a high-level logical flowchart diagram illustrating an exemplary method for implementing predictive capacity on demand for systems with active power management according to a preferred embodiment of the present invention. The process begins at step 300 and continues to step 302, which illustrates capacity manager 210 setting a count variable resident in system memory 104 equal to zero. The process continues to step 304, which illustrates capacity manager 210 determining if the value of the count variable is less than the number of additional processing units 102a-n that a user wants to license. If the count variable is not less than the number of additional processing units 102a-n that the user wants to license, the process ends, as depicted in step 306.

Returning to step 304, if the value of count is less than the number of processing units 102a-n the user wants to license, the process proceeds to step 308, which illustrates capacity manager 210 estimating the incremental power for an additional processing unit. As discussed above, the incremental power for an additional processing unit is expressed as ProcessorPower(AverageEffectiveFrequency)=(MeasuredProcessorPower/NumberofLicensedProcessingUnits). Capacity manager 210 calculates the power headroom, as illustrated in step 310. The power headroom, as previously discussed, is expressed as PHR=ProcessorPowerLimit−MeasuredProcessorPower.

The process continues to step 312, which illustrates capacity manager 210 determining if the power headroom is greater than or equal to zero. If the power headroom is not greater than or equal to zero, the process continues to step 314, which depicts capacity manager 210 calculating an adjusted power headroom, determined by the change in power per processor required by the system, expressed by ChangeInPowerPerProcessor=(|ProjectedPHR])/(NumberofLicensedProcessors+1). The process continues to step 316.

If the power headroom is greater than or equal to zero, the process continues to step 316, which illustrates capacity manager 210 projecting the capacity of data processing system 100 with a newly-incorporated processing unit configured. The process continues to step 318, which illustrates capacity manager 210 increasing the value of the count variable by one. The process returns to step 304 and proceeds in an iterative fashion.

As discussed, the present invention includes a method, apparatus, and computer-usable medium for predicting capacity on a data processing system. According to a preferred embodiment of the present invention, a capacity manager estimates an incremental power value utilize for activating and maintaining an additional processor in the data processing system. The capacity manager calculates a power headroom value. In response to calculating the power headroom value, the capacity manager determines whether an adjustment power headroom value is required. The capacity manager calculates a projected capacity value added by the additional processor to the data processing system.

It should be understood that at least some aspects of the present invention may alternatively be implemented as a program product. Program code defining functions in the present invention can be delivered to a data storage system or a computer system via a variety of signal-bearing media, which include, without limitation, non-writable storage media (e.g., CD-ROM), writable storage media (e.g., hard disk drive, read/write CD-ROM, optical media), system memory such as, but not limited to Random Access Memory (RAM), and communication media, such as computer and telephone networks including Ethernet, the Internet, wireless networks, and like network systems. It should be understood, therefore, that such signal-bearing media when carrying or encoding computer-readable instructions that direct method functions in the present invention represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made therein without departing from the spirit and scope of the invention.

What is claimed is:

1. A computer-implementable method for predicting capacity on a data processing system, said method comprising:
estimating an incremental power value utilized for activating and maintaining an additional processor in said data processing system;
calculating a power headroom value;
in response to said calculating said power headroom value, determining whether an adjustment power headroom value is required; and
calculating a projected capacity value added by said additional processor to said data processing system.

2. The computer-implementable method according to claim 1, further comprising:
in response to determining said adjustment power headroom value is required, calculating said adjustment value.

3. The computer-implementable method according to claim 1, wherein said incremental power value is a measured processor power value divided by a number of currently licensed processors in said data processing system.

4. The computer-implementable method according to claim 1, wherein said power headroom value is an additional power load from newly-licensed processors said data processing system can tolerate before invoking a power management system.

5. The computer-implementable method according to claim 1, wherein said adjustment power headroom value is determined by a change in power per processor divided by the number of licensed processors currently in said data processing system plus one.

6. A system for predicting capacity on a data processing system, said system comprising:
a plurality processors;
a data bus coupled to said plurality of processors;
a computer-usable medium embodying computer program code, said computer-usable medium being coupled to said data bus, said computer program code comprising instructions executable by said plurality processors and configured for:
estimating an incremental power value utilized for activating and maintaining an additional processor in said data processing system;
calculating a power headroom value;
in response to said calculating said power headroom value, determining whether an adjustment power headroom value is required; and
calculating a projected capacity value added by said additional processor to said data processing system.

7. The system according to claim 6, wherein said instructions are further configured for:
in response to determining said adjustment power headroom value is required, calculating said adjustment value.

8. The system according to claim 6, wherein said incremental power value is a measured processor power value divided by a number of currently licensed processors in said data processing system.

9. The system according to claim 6, wherein said power headroom value is an additional power load from newly-licensed processors said data processing system can tolerate before invoking a power management system.

10. The system according to claim 6, wherein said adjustment power headroom value is determined by a change in power per processor divided by the number of licensed processors currently in said data processing system plus one.

11. A computer-usable medium embodying computer program code, said computer program code comprising computer-executable instructions configured for:
estimating an incremental power value utilized for activating and maintaining an additional processor in said data processing system;
calculating a power headroom value;
in response to said calculating said power headroom value, determining whether an adjustment power headroom value is required; and
calculating a projected capacity value added by said additional processor to said data processing system.

12. The computer-usable medium according to claim 11, wherein said embodied computer program code further comprises computer-executable instructions configured for:
in response to determining said adjustment power headroom value is required, calculating said adjustment value.

13. The computer-usable medium according to claim 11, wherein said incremental power value is a measured processor power value divided by a number of currently licensed processors in said data processing system.

14. The computer-usable medium according to claim 11, wherein said power headroom value is an additional power load from newly-licensed processors said data processing system can tolerate before invoking a power management system.

15. The computer-usable medium according to claim 11, wherein said adjustment power headroom value is determined by a change in power per processor divided by the number of licensed processors currently in said data processing system plus one.
